(19) United States
(12) Patent Application Publication
(10) Pub. No.: US 2024/0092107 A1
(43) Pub. Date: Mar. 21, 2024

(54) METHOD OF TRANSFERRING COLOR IMAGES TO POLYMER CLAY

(71) Applicant: Stephanie Dasher, Valrico, FL (US)

(72) Inventor: Stephanie Dasher, Valrico, FL (US)

(21) Appl. No.: 17/933,664

(22) Filed: Sep. 20, 2022

(51) Int. Cl. B41M 5/00

(52) U.S. Cl. CPC B41M 5/0064

(57) ABSTRACT

A method of transferring color images to polymer clay using a combination of laser printer loaded with water-soluble material is disclosed. A color image may be printed on water-soluble material, producing a color image transfer sheet having a color image side. The color image side may be burnished against a surface of polymer clay. Subjecting the color image transfer sheet or portions thereof to water, dissolves the transfer sheet but leaves the color image on the polymer clay surface.

### BACKGROUND OF THE INVENTION

The present invention relates to polymer clay techniques and, more particularly, a method of transferring color images to polymer clay.

Polymer clay is a type of modeling clay that can be put into an oven to harden. Polymer clay is generally used for making arts and craft items and is also used in commercial applications to make decorative parts. One form of craftwork or artisanship that has eluded the user of polymer clay, for craft and commercial applications, is an inexpensive and convenient way to transfer color and detailed images onto polymer clay.

Sure, there are transfer sheets that use glaze, but these will only work with ceramic clay and not with polymer clay. Other transfer sheets that transfer images onto clay only work with specific polymer clay brands and their application is a time-consuming portion of a long process.

In sum, other image transfers are too time consuming and do not work with all brands of polymer clay.

As can be seen, there is a need for an improved method of transferring color images to polymer clay.

The method of the present invention embodies clay tattoo transfer sheets that save the time needed to transfer images relative to the prior art. The transfer sheet methodology of the present invention improves the image quality of transfers as well. The present invention enables users to use any type or brand of polymer clay during the disclosed method. The present invention allows for detailed color images to be transferred quicker than the prior art onto any brand of polymer clay, and yield a crisp result.

### SUMMARY OF THE INVENTION

In one aspect of the present invention, a method of transferring images to a polymer clay, the method comprising urging an image against the polymer clay, wherein the image is fused by way of a laser-printing ink on a water-soluble medium.

In another aspect of the present invention, the method of transferring images to a polymer clay further includes subjecting the water-soluble medium to water to remove it from the polymer clay, wherein the laser-printing ink is a dry mixture of plastic particles and carbon, wherein the water-soluble medium is paper, wherein the image is in color, wherein the image is in color and wherein the laser-printing ink further includes coloring agents, and further including loading the water-soluble paper in a laser printer prior to creating said image, further including manipulating the image on a computer prior to printing it to the water-soluble medium, wherein the image is on one side of the water-soluble medium, and wherein the one side is urged against the polymer clay, and further including flattening the polymer clay prior to urging of the image.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention.

FIG. 2 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

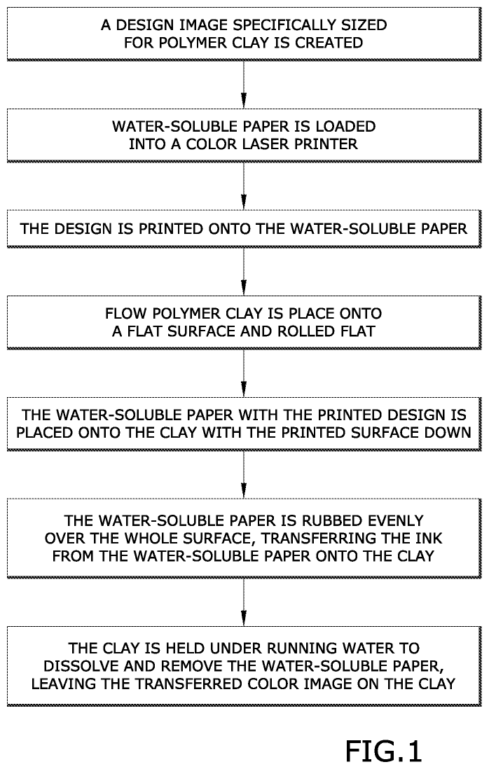

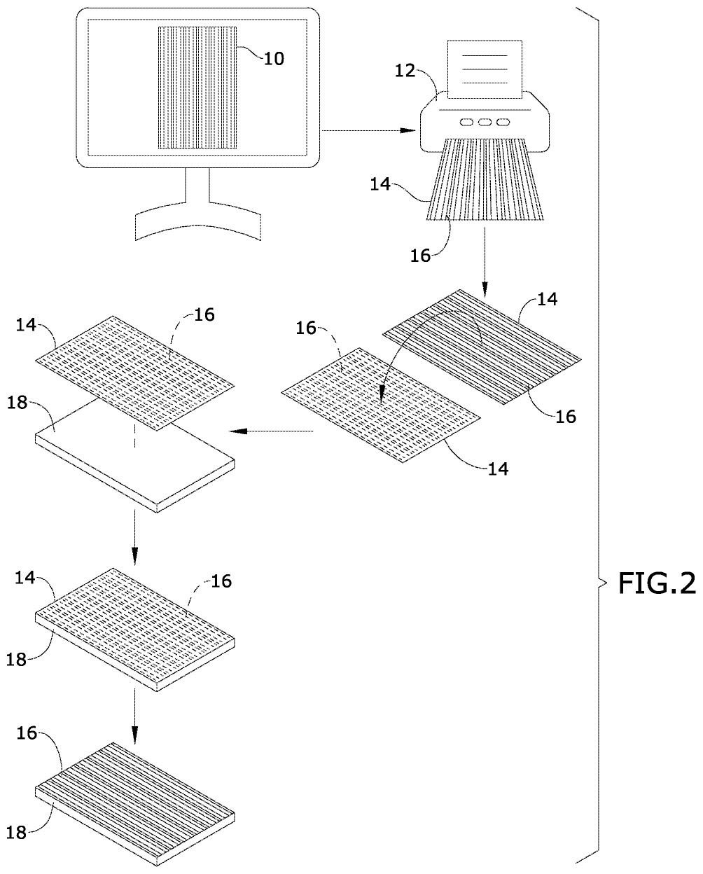

Referring now to FIGS. 1 and 2, the present invention may include a method of transferring color images to polymer clay embodying the following steps. First, a design image 10 specifically sized for polymer clay may be created. Proper sizing may include dimensioning and proportioning particularly for a preselected or typically or conventionally sized clay slabs. Second, water-soluble paper 14 may be loaded into a color laser printer 12. Third, the design is printed onto the water-soluble paper, as a water-soluble print 16. The water-soluble print 16 may, in effect, be a clay tattoo transfer sheet 16. Fourth, flow polymer clay is place onto a flat surface and rolled flat. Fifth, the water-soluble paper with the printed design is placed onto the clay with the printed surface down. Sixth, the water-soluble paper is rubbed or burnished evenly over the whole surface, transferring the ink from the water-soluble paper onto the clay. Finally, seventh, the clay is subjected to water to dissolve and remove the water-soluble paper, leaving the transferred color image on the polymer clay 18.

The design image 10 may be digitally created on a computing device (or could be exported thereto). It is also understood that the transfer sheet's image may be urged against non-flat surfaces of polymer claim 18.

Water-soluble paper 14 alone is not enough for the color image transfers embodied in the present invention to work. The water-soluble paper 14 must be used in combination with a color laser printer 12 to yield a high-quality color image transfer. Likewise, a color laser printer 12 is not capable of creating the image transfer without using the special water-soluble paper 14. Water-soluble paper and color laser toner ink as a combination are critical; these items cannot be substituted with other materials. Color laser toner ink contains toner powder, a fine, dry mixture of plastic particles, carbon, and black or other coloring agents that make the actual image on the paper. The toner is transferred to paper via an electrostatically charged drum unit and fused onto the medium/paper by heated rollers during the printing process. It does not stain the medium like ink conventional cartridges. This is what is meant by laser-printing ink, wherein “printing” is fusing of dry mixture of plastic particles, carbon, and black or other coloring agents onto the medium loaded in the laser printer.

A method of using the present invention may include the following. The user places the clay tattoo sheet image transfer sheet 16 face down onto the clay slab 18, and then the user rubs/burnishes the clay tattoo transfer sheet 16 onto the clay slab 18. The user may hold the clay slab 18 under gently running water until the water-soluble transfer sheet 16 has resolved or dissolved, and the color image 10 from the computer is transferred to the surface of the clay slab 18.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A method of transferring images to a polymer clay, the method comprising urging an image against the polymer clay, wherein the image is fused by way of a laser-printing ink on a water-soluble medium.

2. The method of claim 1, further comprising subjecting the water-soluble medium to water to remove it from the polymer clay.

3. The method of claim 2, wherein the laser-printing ink is a mixture of plastic particles and carbon.

4. The method of claim 3, wherein the water-soluble medium is water-soluble paper.

5. The method of claim 4, wherein the image is in color.

6. The method of claim 5, wherein the image is in color and wherein the laser-printing ink further includes coloring agents.

7. The method of claim 6, further comprising loading the water-soluble medium in a laser printer prior to creating said image.

8. The method of claim 7, further comprising manipulating the image on a computer prior to printing it to the water-soluble medium.

9. The method of claim 8, wherein the image is on one side of the water-soluble medium, and wherein the one side is urged against the polymer clay.

10. The method of claim 9, further comprising flattening the polymer clay prior to urging of the image.
